(19) United States
(12) Patent Application Publication
(10) Pub. No.: US 2010/0126876 A1
(43) Pub. Date: May 27, 2010

(54) Water Purification

(76) Inventor: Bruce H. Peters, Colorado Springs, CO (US)

Correspondence Address: HANES & SCHUTZ, LLC, 102 SOUTH TEJON ST., SUITE 800, COLORADO SPRINGS, CO, 80903, US

(21) Appl. No.: 12/277,134

(22) Filed: Nov. 24, 2008

(51) Int. Cl. C25B 1/04; F02G 1/00

(52) U.S. Cl. 205/628; 60/39.6; 60/783

(57) ABSTRACT

A water purification system has a water electrolysis system, combustion evaporation, and condensation chambers; hydrogen and oxygen channels; and a water vapor conduit. The water electrolysis system generates hydrogen and oxygen from water. The hydrogen and oxygen are transported to the oxygen chamber in channels. The hydrogen is combusted in the oxygen in the combustion chamber to generate heated water vapor. The evaporation chamber generates water vapor from water. The water vapor conduit is disposed between the evaporation chamber and the condensation chamber. Heated water vapor from the combustion chamber traveling from the combustion chamber into the condensation chamber generates a vacuum on the water vapor conduit, drawing water vapor from the evaporation chamber into the condensation chamber. The condensation chamber receives water vapor from both the combustion chamber and the evaporation chamber. Water vapor from the combustion chamber and the evaporation chamber are condensed into purified liquid water.

### BACKGROUND

A vast number of people throughout the world lack access to a healthy drinking water supply. Many of those people live near water sources, but the water from those sources is unfit for drinking and the people have no ready means of purifying the water.

### DESCRIPTION OF THE DRAWINGS

FIG. 1 is an illustration of an embodiment of the present invention system for purifying water.

FIG. 2 is a flow chart illustrating one embodiment of the present invention method for purifying water.

### DETAILED DESCRIPTION

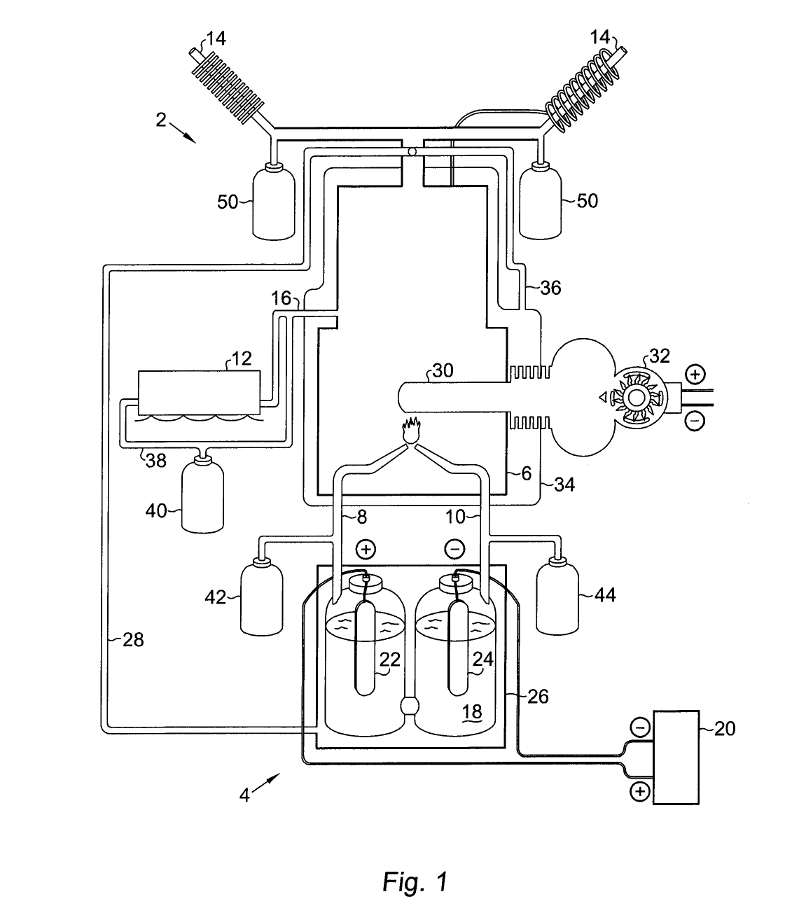

FIG. 1 illustrates an embodiment of the present invention system 2 for water purification. Water purification system 2 includes water electrolysis system 4, combustion chamber 6, oxygen channel 8, hydrogen channel 10, evaporation chamber 12, condensation chamber 14, and water vapor conduit 16.

Water electrolysis system 4 generates hydrogen and oxygen from water. In one embodiment, water electrolysis system 4 includes electrolytic chamber 18 and direct current voltage source 20. Direct current voltage source is any source of direct current, either originating as direct current or rectified to direct current from alternating current, such as solar, wind, or nuclear power, power generated from an external combustion engine 30, or any other direct current voltage source.

Direct current voltage source 20 has anode 22 and cathode 24. Both anode 22 and cathode 24 are disposed in electrolytic chamber 18. Water 26 in electrolytic chamber 18 is decomposed into oxygen and hydrogen at anode 22 and cathode 24, respectively.

In addition to hydrogen and oxygen, the water electrolysis process also generates heat. In one embodiment, system 2 further includes means for capturing heated air from the water electrolysis process and means for introducing the captured heated air into combustion chamber 6 to augment the vacuum generated by the heated water vapor traveling from combustion chamber 6 to condensation chamber 14.

Examples of the means for capturing the heated air include a jacket or casing 26 surrounding electrolytic chamber 18. The heated air is generated between electrolytic chamber 18 and jacket 26 and introduced into combustion chamber 6 through heated air channel 28 between jacket 26 and combustion chamber 6.

Hydrogen channel 10 is disposed to transport hydrogen from water electrolysis system 4 to combustion chamber 6. Oxygen channel 8 is disposed to transport oxygen from water electrolysis system 4 to combustion chamber 6. In one embodiment, all of the hydrogen and oxygen generated from the water electrolysis process is transported to combustion chamber 6.

In an alternative embodiment, some of the oxygen and hydrogen generated from the water electrolysis process is stored for future use or for other uses. Hydrogen storage system 38 is in fluid communication with hydrogen channel 10 and oxygen storage system 40 is in fluid communication with oxygen channel 8 so that some of the hydrogen and oxygen may be stored.

Combustion chamber 6 is a chamber for combusting hydrogen from electrolysis system 4 in oxygen from electrolysis system 4 to generate heated water vapor. In addition to water vapor, the combustion process also generates heat. In one embodiment combustion chamber 6 is tightly insulated to ensure that as much of the heat generated by the combustion process as possible is contained within combustion chamber 6 and flows with heated water vapor into condensation chamber 14.

In one embodiment, system 2 further includes means for capturing air external to combustion chamber 6, heated from the combustion process within combustion chamber 6 and means for introducing the captured heated air into combustion chamber 6 to augment the vacuum generated by the heated water vapor traveling from combustion chamber 6 to condensation chamber 14.

Examples of the means for capturing the heated air include a jacket or casing 34 surrounding combustion chamber 6. The heated air is generated between combustion chamber 6 and jacket 34 and introduced into combustion chamber 6 through heated air channel 36 between jacket 34 and combustion chamber 6.

In one embodiment, system 2 further includes external combustion engine 30 and electrical power generation system 32. One example of an external combustion engine is a Stirling engine. Another example of an external combustion engine is a steam engine. External combustion engine 30 is disposed to utilize the combustion of hydrogen within combustion chamber 6 as a source of external combustion. Electrical power generation system 32 is powered by external combustion engine 30 and, in one embodiment, provides electrical power to direct current voltage source 20.

Evaporation chamber 12 generates water vapor from water. In one embodiment, evaporation chamber 12 is disposed on a body of water. In one embodiment, evaporation chamber 12 is a passive solar evaporation chamber. In alternate embodiments, evaporation chamber 12 may be any type of chamber for evaporating water to form water vapor.

In one embodiment, evaporation chamber 12 has a clear top and an open bottom. The open bottom rests in a body of water, such as salt water or other non-potable water source.

Water vapor conduit 16 is disposed between evaporation chamber 12 and condensation chamber 14. As heated water vapor from combustion chamber 6 travels from combustion chamber 6 into condensation chamber 14, a Venturi effect is created, which generates a vacuum on water vapor conduit 16. The vacuum draws water vapor from evaporation chamber 12 into condensation chamber 14.

In one embodiment, system 2 further includes condensing pipe 38 and collection chamber 40. Although referred to as a pipe, condensing pipe 38 may be any type of fluid carrying conduit, such as a pipe, tube, or hose.

Condensing pipe 38 is disposed in a body of water and interconnects water vapor conduit 16 and condensation chamber 14. Water vapor drawn from evaporation chamber 12 first passes through condensing pipe 38, then through water vapor conduit 16 and into condensation chamber 14. Water vapor passing through condensing pipe 38 is condensed into purified liquid water.

Collection chamber 40 is in fluid communication with condensing pipe 38. Collection chamber 40 is also disposed in the body of water, below condensing pipe 38. Purified liquid water in condensing pipe 38 flows by gravity into collection chamber 40.

Condensation chamber 14 allows water vapor to cool, which causes it to condense to purified liquid water. In one embodiment, condensation chamber 14 is cooled by air. In an alternative embodiment, condensation chamber 14 is cooled by water.

Condensation chamber 14 is disposed to receive water vapor from both combustion chamber 6 and evaporation chamber 12. In one embodiment, condensation chamber 14 is disposed above combustion chamber 6 so that as the heated water vapor naturally rises, it flows into condensation chamber 14.

Water vapor in condensation chamber 14 is condensed into purified liquid water in condensation chamber 14. Receiving water vapor from both combustion chamber 6 and evaporation chamber 12 produces more purified liquid water than receiving water vapor from only combustion chamber 6.

The condensed, purified, liquid water may be immediately distributed or collected in storage containers 50. Storage containers 50 are any container suitable for the storage of purified liquid water, such as barrels, jars, wells, cylinders, and the like.

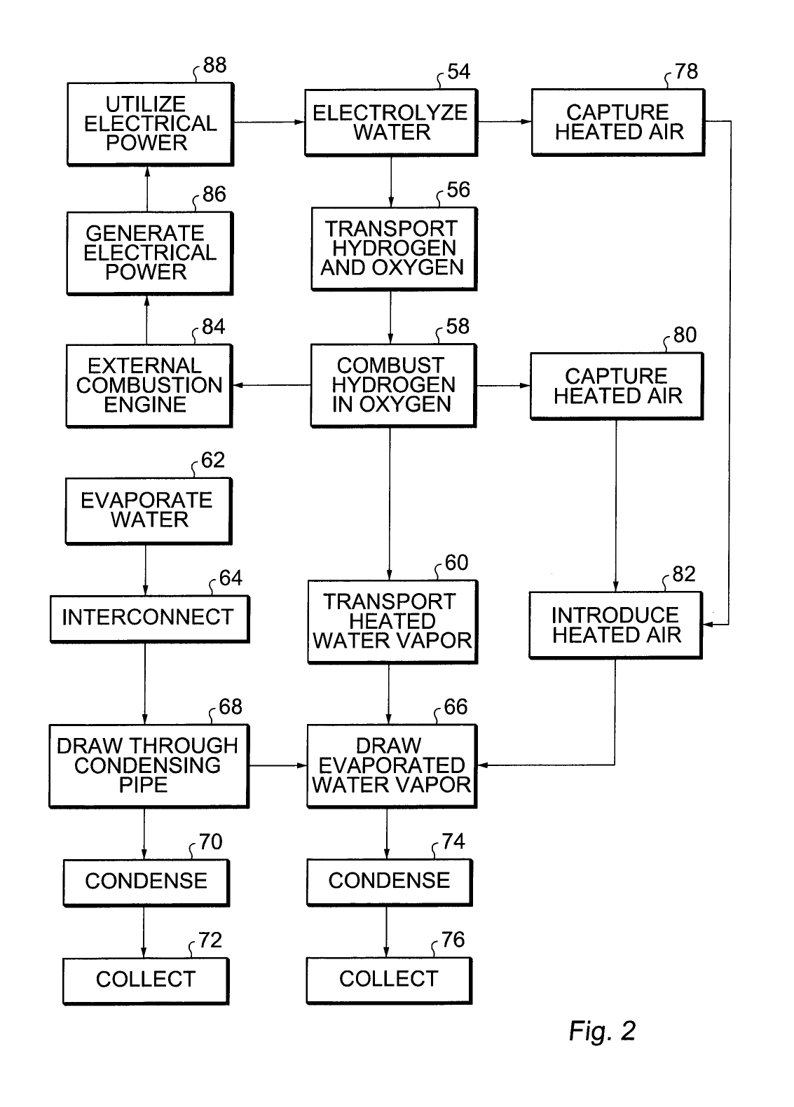

FIG. 2 is a flow chart representing steps of one embodiment method for purifying water. Although the steps represented in FIG. 2 are presented in a specific order, the technology presented herein can be performed in any variation of this order. Furthermore, additional steps may be executed between the steps illustrated in FIG. 2.

Water is electrolyzed 54 to generate hydrogen and oxygen. The hydrogen and oxygen are transported 56 to combustion chamber 6. The hydrogen is combusted 58 in the oxygen in combustion chamber 6 to generate heated water vapor.

The heated water vapor is transported 60 from combustion chamber 6 to condensation chamber 14. The heated water vapor moves across an opening to the water vapor conduit 16, in so doing, a vacuum is generated within water vapor conduit 16.

During this process, water is evaporated 62 in evaporation chamber 12 to form water vapor. In one embodiment, water vapor conduit 16 connects directly to evaporation chamber 12. In an alternate embodiment, condensing pipe 38 interconnects 64 water vapor conduit 16 and condensation chamber 12.

The vacuum, generated by transporting 60 the heated water vapor from combustion chamber 6, draws 66 evaporated water vapor from evaporation chamber 12. Where condensing pipe 38 interconnects 64 water vapor conduit 16 and condensation chamber 12, evaporated water vapor is also drawn 68 from evaporation chamber 12. At least some of the evaporated water vapor passing through condensing pipe 38 condenses 70 into purified liquid water. The purified liquid water is collected 72 in collection chamber 40.

The evaporated water vapor passing through water vapor conduit 16 joins the heated water vapor in condensation chamber 14 where they are both condensed 74 to purified liquid water and collected 76. Condensing 74 water vapor from both the combustion 58 and the evaporation 62 produces more purified liquid water than receiving water vapor from only the combustion. Any remaining air is exhausted out of condensation chamber 14.

In order to improve the efficiency of the process, heated air may be captured 78, 80 from both the electrolysis process 54 and the combustion process 58. The captured heated air is introduced 82 into combustion chamber 6 to augment the vacuum generated by the heated water vapor traveling from combustion chamber 6 to condensation chamber 14.

An additional improvement to the efficiency of the process allows external combustion engine 30 to operate 84 from the combustion 58 of hydrogen in combustion chamber 6. Electrical power is generated 86 from the operation of external combustion engine 30. The electrical power may then be utilized as desired. In one embodiment, the electrical power is utilized in the electrolyzing 54 of water.

The foregoing description is only illustrative of the invention. Various alternatives and modifications can be devised by those skilled in the art without departing from the invention. Accordingly, the present invention embraces all such alternatives, modifications, and variances that fall within the scope of the appended claims.

What is claimed is:

1. A water purification system, the system comprising:
a water electrolysis system for generating hydrogen and oxygen from water;
a combustion chamber for combusting hydrogen from the electrolysis system in oxygen from the electrolysis system to generate heated water vapor;
a hydrogen channel disposed to transport hydrogen from the water electrolysis system to the combustion chamber;
an oxygen channel disposed to transport oxygen from the water electrolysis system to the combustion chamber;
an evaporation chamber for generating water vapor from water;
a condensation chamber disposed to receive water vapor from both the combustion chamber and the evaporation chamber for condensing the water vapor into purified liquid water, wherein receiving water vapor from both the combustion chamber and the evaporation chamber produces more purified liquid water than receiving water vapor from only the combustion chamber; and
a water vapor conduit between the evaporation chamber and the condensation chamber, wherein heated water vapor from the combustion chamber traveling from the combustion chamber into the condensation chamber generates a vacuum on the water vapor conduit, drawing water vapor from the evaporation chamber into the condensation chamber.

2. The system of claim 1 wherein the water electrolysis system includes:
an electrolytic chamber and
a direct current voltage source having an anode and a cathode, both disposed in the electrolytic chamber so that water in the electrolytic chamber is decomposed into oxygen and hydrogen at the anode and cathode, respectively.

3. The system of claim 2 further including:
means for capturing heated air from a water electrolysis process within the electrolytic chamber and
means for introducing the captured heated air into the combustion chamber to augment the vacuum generated by the heated water vapor traveling from the combustion chamber to the condensation chamber.

4. The system of claim 1 wherein:
the means for capturing heated air includes a jacket surrounding the electrolytic chamber and
the means for introducing includes a heated air channel between the jacket and the combustion chamber.

5. The system of claim 1 further including:
an external combustion engine disposed to utilize the combustion of hydrogen within the combustion chamber as a source of external combustion and
a electrical power generation system powered by the external combustion engine and providing electrical power to the direct current voltage source.

6. The system of claim 1 further including:
means for capturing air external to the combustion chamber, heated from a combustion process within the combustion chamber and
means for introducing the captured heated air into the combustion chamber to augment the vacuum generated by the heated water vapor traveling from the combustion chamber to the condensation chamber.

7. The system of claim 6 wherein:
the means for capturing heated air includes a jacket surrounding the combustion chamber and
the means for introducing includes a heated air channel between the jacket and the combustion chamber.

8. The system of claim 1 further including:
an oxygen storage system in fluid communication with the oxygen channel and
a hydrogen storage system in fluid communication with the hydrogen channel.

9. The system of claim 1 wherein, the evaporation chamber is a passive solar evaporation chamber disposed on a body of water.

10. The system of claim 1 further including:
a condensing pipe disposed in the body of water and interconnecting the water vapor conduit and the condensation chamber so that water vapor drawn from the evaporation chamber first passes through the condensing pipe, then through the water vapor conduit and into the condensation chamber and
a collection chamber in fluid communication with the condensing pipe and disposed in the body of water below the condensing pipe so as to collect water condensed from the water vapor passing through the condensing pipe.

11. A method for purifying water, the method comprising:
electrolyzing water to generate hydrogen and oxygen;
transporting the hydrogen and the oxygen to a combustion chamber;
combusting the hydrogen in the oxygen in a combustion chamber to generate heated water vapor;
transporting the heated water vapor from the combustion chamber to a condensation chamber and thereby generating a vacuum;
evaporating water to form water vapor;
utilizing the generated vacuum to draw the evaporated water vapor into the condensation chamber; and
condensing the heated water vapor and the evaporated water vapor to obtain purified liquid water, wherein condensing water vapor from both the combustion and the evaporation produces more purified liquid water than receiving water vapor from only the combustion; and

12. The method of claim 11 further including:
capturing air heated as a byproduct of electrolyzing the water and
introducing the captured heated air into the combustion chamber to augment the vacuum generated by the heated water vapor traveling from the combustion chamber to the condensation chamber.

13. The method of claim 11 further including:
capturing air external to the combustion chamber, heated as a byproduct of combusting the hydrogen in the oxygen within the combustion chamber and
introducing the captured heated air into the combustion chamber to augment the vacuum generated by the heated water vapor traveling from the combustion chamber to the condensation chamber.

14. The method of claim 11 further including:
operating an external combustion engine from the combustion of hydrogen in the combustion chamber;
generating electrical power from the external combustion engine; and
utilizing the electrical power in the electrolyzing of water.

15. The method of claim 11 further including:
interconnecting the water vapor conduit and a condensation chamber with a condensing pipe disposed in a body of water;
wherein evaporated water vapor drawn from the evaporation chamber first passes through the condensing pipe, then through the water vapor conduit and into the condensation chamber;
condensing evaporated water vapor in the condensing pipe; and
collecting the water condensed from the water vapor passing through the condensing pipe.
